(19) United States
(12) Patent Application Publication
(10) Pub. No.: US 2026/0203792 A1
(43) Pub. Date: Jul. 16, 2026

(54) METHODS AND APPARATUSES FOR CONTENT MANAGEMENT

(71) Applicant: Lane Franks, Alpine, UT (US)

(72) Inventor: Lane Franks, Alpine, UT (US)

(21) Appl. No.: 19/447,908

(22) Filed: Jan. 13, 2026

Related U.S. Application Data
(60) Provisional application No. 63/745,248, filed on Jan. 14, 2025.

(51) Int. Cl. G06Q 30/0251

(52) U.S. Cl. CPC G06Q 30/0257

(57) ABSTRACT

Described herein are methods and apparatuses for content management. One method performed by a content server includes: receiving, from a subscriber device, a subscription request including a subscriber identifier and a subscriber time stamp associated with the subscriber identifier; comparing the subscriber identifier to a plurality of content set identifiers; in response to the subscriber identifier matching a content set identifier of the plurality of content set identifiers, comparing the subscriber time stamp to a set of content time stamps corresponding to the content set identifier; and, in response to the subscriber time stamp matching a content time stamp of the set of content time stamps, transmitting, to the subscriber device, a subscription response including a first content associated with the content time stamp.

### PRIORITY

This application claims priority to U.S. Application No. 63/745,248 filed on Jan. 14, 2025, which is hereby incorporated herein in its entirety.

### FIELD

This disclosure relates generally to digital content distribution and subscription-based content delivery systems, and more particularly to systems, methods, and apparatuses for managing, registering, distributing, tracking, and monetizing content using identifier-based subscription mechanisms.

### BACKGROUND

Modern consumers are exposed to extremely large volumes of digital content across multiple media channels, including broadcast media, streaming services, social media platforms, mobile applications, outdoor advertising, and in-venue displays. While such content provides opportunities for engagement, the sheer volume of content creates significant challenges for both consumers and content providers.

From a consumer perspective, it is often difficult to efficiently identify, retain, and later access content that is momentarily interesting or relevant. Many conventional mechanisms—such as scanning QR codes, manually searching for hashtags, following social media accounts, or bookmarking URLs—require immediate action and frequently interrupt the consumer's experience.

From a content provider perspective, existing mechanisms provide limited control, limited ownership of identifiers, and limited insight into consumer engagement. Hashtags are generally non-exclusive, noisy, and difficult to track. QR codes require visual proximity and provide limited opportunities for follow-up engagement.

### SUMMARY

The subject matter of the present application has been developed in response to the present state of the art, and in particular, in response to shortcomings of content management.

Accordingly, the subject matter of the present application has been developed to provide compositions and methods that overcomes at least some of the above-discussed shortcomings of prior art techniques.

In one embodiment, a method performed by a content server comprises: receiving, from a subscriber device, a subscription request comprising a subscriber identifier and a subscriber time stamp associated with the subscriber identifier; comparing the subscriber identifier to a plurality of content set identifiers; in response to the subscriber identifier matching a content set identifier of the plurality of content set identifiers, comparing the subscriber time stamp to a set of content time stamps corresponding to the content set identifier; and, in response to the subscriber time stamp matching a content time stamp of the set of content time stamps, transmitting, to the subscriber device, a subscription response comprising a first content associated with the content time stamp.

In certain embodiments, the subscription response comprises the subscriber identifier.

In some embodiments, the method further comprises associating a second content with the first content.

In various embodiments, the method further comprises transmitting the second content to the subscriber device after a predetermined time period.

In one embodiment, the method further comprises receiving a notification in response to the first content being accessed at the subscriber device.

In certain embodiments, the method further comprises transmitting a second content associated with the first content to the subscriber device in response to receiving the notification.

In some embodiments, the method further comprises storing information corresponding to receiving the subscription request.

In various embodiments, the method further comprises associating a user identifier corresponding to the subscriber device with the stored information.

In one embodiment, the method further comprises receiving a plurality of subscription requests comprising a plurality of subscriber identifiers associated with a corresponding subscriber time stamp of a plurality of subscriber time stamps.

In certain embodiments, the method further comprises storing information corresponding to the plurality of subscription requests.

In some embodiments, the method further comprises associating a user identifier corresponding to the subscriber device with the stored information.

In various embodiments, the subscription request comprises a subscriber location.

In one embodiment, the subscriber location comprises a geospatial positioning system (GPS) location.

In certain embodiments, the subscriber identifier comprises a word or phrase.

In some embodiments, the first content comprises a uniform resource locator (URL).

In one embodiment, a content server comprises: at least one memory; and at least one processor coupled with the at least one memory and configured to cause the content server to: receive, from a subscriber device, a subscription request comprising a subscriber identifier and a subscriber time stamp associated with the subscriber identifier; compare the subscriber identifier to a plurality of content set identifiers; in response to the subscriber identifier matching a content set identifier of the plurality of content set identifiers, compare the subscriber time stamp to a set of content time stamps corresponding to the content set identifier; and, in response to the subscriber time stamp matching a content time stamp of the set of content time stamps, transmit, to the subscriber device, a subscription response comprising a first content associated with the content time stamp.

In one embodiment, a processor comprises: at least one controller coupled with at least one memory and configured to cause the processor to: receive, from a subscriber device, a subscription request comprising a subscriber identifier and a subscriber time stamp associated with the subscriber identifier; compare the subscriber identifier to a plurality of content set identifiers; in response to the subscriber identifier matching a content set identifier of the plurality of content set identifiers, compare the subscriber time stamp to a set of content time stamps corresponding to the content set identifier; and, in response to the subscriber time stamp matching a content time stamp of the set of content time stamps, transmit, to the subscriber device, a subscription response comprising a first content associated with the content time stamp.

In one embodiment, a method performed by a subscriber device comprises: receiving a subscriber identifier; associating a subscriber time stamp with the subscriber identifier; transmitting, to a content server, a subscription request comprising the subscriber identifier and the subscriber time stamp, wherein: the subscriber identifier is compared to a plurality of content set identifiers; and in response to the subscriber identifier matching a content set identifier of the plurality of content set identifiers, the subscriber time stamp is compared to a set of content time stamps corresponding to the content set identifier; and, in response to the subscriber time stamp matching a content time stamp of the set of content time stamps, receiving, from the content server, a subscription response comprising a first content associated with the content time stamp.

In certain embodiments, the method further comprises associating a subscriber location with the subscriber identifier.

In one embodiment, a subscriber device comprises: at least one memory; and at least one processor coupled with the at least one memory and configured to cause the subscriber device to: receive a subscriber identifier; associate a subscriber time stamp with the subscriber identifier; transmit, to a content server, a subscription request comprising the subscriber identifier and the subscriber time stamp, wherein: the subscriber identifier is compared to a plurality of content set identifiers; and, in response to the subscriber identifier matching a content set identifier of the plurality of content set identifiers, the subscriber time stamp is compared to a set of content time stamps corresponding to the content set identifier; and, in response to the subscriber time stamp matching a content time stamp of the set of content time stamps, receive, from the content server, a subscription response comprising a first content associated with the content time stamp.

In one embodiment, a processor comprises: at least one controller coupled with at least one memory and configured to cause the processor to: receive a subscriber identifier; associate a subscriber time stamp with the subscriber identifier; transmit, to a content server, a subscription request comprising the subscriber identifier and the subscriber time stamp, wherein: the subscriber identifier is compared to a plurality of content set identifiers; and, in response to the subscriber identifier matching a content set identifier of the plurality of content set identifiers, the subscriber time stamp is compared to a set of content time stamps corresponding to the content set identifier; and, in response to the subscriber time stamp matching a content time stamp of the set of content time stamps, receive, from the content server, a subscription response comprising a first content associated with the content time stamp.

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter, they are not therefore to be considered to be limiting of its scope. The subject matter will be described and explained with additional specificity and detail through the use of the drawings, in which:

FIG. 1 is a schematic diagram of one embodiment of marketing material;

FIG. 2 is a schematic diagram of one embodiment of a subscriber device;

FIG. 3 is a schematic diagram of another embodiment of a subscriber device;

FIG. 4 is a schematic diagram of one embodiment of a marketer server (content server);

FIG. 5 is a schematic diagram of one embodiment of a method of content management; and

FIG. 6 is a schematic diagram of another embodiment of a method of content management.

### DETAILED DESCRIPTION

Described herein are various embodiments for content management that enable subscriber-initiated, identifier-based access to digital content with temporal disambiguation and controlled follow-up delivery.

As described herein, content may include images, video, audio, text, hyperlinks, application resources, social media aggregation pages, promotional offers, or combinations thereof. Such content may be presented to users via broadcast media, streaming media, mobile applications, web interfaces, physical signage, or in-venue displays. The disclosed system enables a user to express interest in such content at a moment of exposure and to retrieve the correct content instance at a later time without requiring immediate interaction.

The various embodiments of content management may overcome one or more of the following problems with content management: 1) on average consumers may have to see or hear content seven times before the consumers act on the content (e.g., rule of seven); 2) it may be difficult for consumers to find specific content they are interested in; 3) consumers may see or hear from 250 to 2000 images and/or messages daily; and 4) the effectiveness of content may not be able to be determined (e.g., lack of metrics). It should be noted that content as described herein may include images, videos, text messages, email messages, and the like. This content may be shown on a social media platform, an application, or via another implementation. The content may correspond to an advertisement, a commercial, and/or a subscription.

Certain content may try to get consumers and/or users to perform some action such as calling a phone number, scanning a QR code, accessing a website, and/or following the content (e.g., on social media). These actions may have drawbacks. For example, QR codes: may only apply to closeup print, may have poor user experience, may not have revenue models, and/or may not have an ability for a provider to follow-up. As another example, hashtags may: have a lack of control, have a lack of ownership, be noisy, be overused, and/or be a risk to the producer. As a further example, the use of text messages (e.g., SMS short messages) may cause consumers to have a fear of being spammed and/or may not have an aggregation point.

Described herein are various ways that content management can overcome the problems seen by other content management systems. For example, the rule of seven may be reduced to consumers only seeing content one or two times before acting. Moreover, a consumer may be taken directly to content that they are interested in. Further, consumers may be able to tag an item they are interested in and the consumer may be able to review the item later. In addition, the content management system described herein may provide metrics corresponding to content.

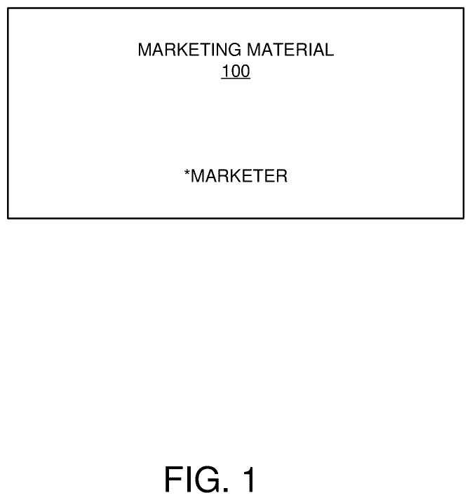

FIG. 1 illustrates an example in which marketing material 100 (e.g., flyer, website, billboard, advertisement, mailer, email, etc.) includes a visible identifier, referred to herein as a snagtag, associated with a marketer or content provider. In certain embodiments, the snagtag is identified by a specific symbol, such as an asterisk (“*”), that is visually or audibly associated with a word, phrase, or brand name. For example, a snagtag may be presented as “*MARKETER” or “*EVENT” to indicate that the associated word or phrase is snagtag-enabled and may be used by a subscriber to access corresponding content. As illustrated in the figures, the term “MARKETER” is representative of a company, brand, organization, or other entity that is marketing content, products, services, or information to an individual user or consumer, and is not limited to any particular industry, size, or business model. In other embodiments, the snagtag may be identified using other symbols, characters, prefixes, suffixes, or visual indicators, such as a carrot symbol (\hat{ }), an equals symbol (=), a plus symbol (+), a custom glyph, an audio cue, or a designated formatting style. The presence of the snagtag indicates to a user that the associated content is available for subscription via a subscriber device. The identifier may comprise a word, phrase, symbol, or combination thereof, and may be visually, audibly, or contextually presented with the marketing material. The presence of the identifier indicates to a user that the associated content is available for subscription via a subscriber device.

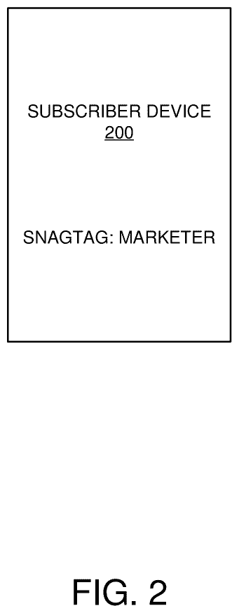

FIG. 2 illustrates a subscriber device 200, such as a mobile phone (e.g., cell phone), computer, computing device, etc., that is capable of receiving user input corresponding to a snagtag. In some embodiments, the subscriber device 200 executes an application that allows the user to enter, select, or otherwise capture the subscriber identifier. Upon capture of the subscriber identifier, the subscriber device associates a subscriber time stamp with the identifier. The subscriber time stamp may correspond to the time at which the user encountered the identifier, such as the time of viewing or hearing the marketing material.

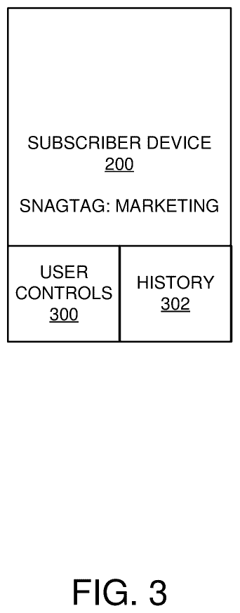

FIG. 3 illustrates additional functionality of the subscriber device 200, including user controls 300 and a history interface 302. The user controls 300 may enable the user to manage subscriptions, including enabling or disabling follow-up content, deleting subscribed content, or marking content as preferred. For example, a consumer may have complete control over whether content remains tagged and whether or not to receive follow-up content and/or offers. A consumer may or may not click the follow-up indicator, turn on and/or off follow-ups, and/or untag/delete tagged items from their subscriptions. The history interface 302 may store previously submitted subscription requests and associated content responses, allowing the user to review content immediately or at a later time. A content management system may enable marketing metrics, such as: 1) a number of tags; 2) a number of views; 3) a number of deletes; 4) a number of shares; 5) a click through rate; 6) a conversion rate; and/or 7) whether content is published to social media locations.

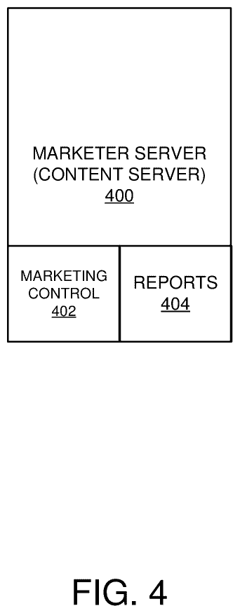

FIG. 4 illustrates a marketer server 400 that may operate as, or in conjunction with, the content server. In certain embodiments, the marketer server 400 and the content server may be implemented as the same physical device, the same logical server, or distributed components of a common system. In other embodiments, the marketer server 400 and the content server may be separate systems operated by the same entity or by different entities and communicatively coupled via one or more networks. Accordingly, references herein to a marketer server or a content server are not intended to require a particular deployment architecture, physical separation, or ownership model, and the disclosed functionality may be implemented using any suitable combination of servers, cloud services, or distributed computing resources. The marketer server 400 may include marketing control functionality 402 and reporting functionality 404. The marketing control functionality 402 may allow a content provider to register identifiers, associate identifiers with content sets, define content time stamps, configure follow-up content, and manage delivery rules. The reporting functionality 404 may generate analytics based on subscription activity, content access, follow-up engagement, geographic distribution, and other metrics. In certain embodiments, the marketer server 400 may include a content management system that may facilitate earning revenue while providing content to consumers and/or subscribers without a fee (e.g., for free). The content management system may make revenue by having producers pay for snagtags, pay for impressions, pay for follow-ups, and/or pay for analytics. The content management system may also use analytics data for remarketing.

In some embodiments, the content management system may enable automatically providing follow-up content. The automatically provided follow-up content may be based on whether prior content has been opened.

In various embodiments, the following metrics may be monitored and/or tracked: demographics of who tagged an item (e.g., age, gender, profile, location), when an item was tagged (e.g., which radio spot was most effective 9:00 am, 12:00 pm, or 5:00 pm), which item was tagged (e.g., GPS coordinates which may indicate an item such as a billboard on an interstate), medium from which the item was tagged, a number of tags, a number of views, a number of times viewed by a user, a number of deletes, a number of items marked as preferred, a number of posts, a number of tweets, a number of shares, a number of referrals, a click through rate, a conversion rate, a cost-per-tag, a cost-per-conversion, a campaign ROI, and so forth.

The marketer server 400 may also include a snagtag registry and/or be in communication with a snagtag registry. A snagtag may be used as a registrar and/or link protocol for any word or phrase. For example, a common registry may be maintained to add, store, and/or remove registered snagtags. Registering a word or phrase as a snagtag may enable access to a secure link protocol that can be used to create a direct link between publishers and subscribers.

It should be noted that the methods described herein describes a possible implementation, and that the operations and the steps may be rearranged or otherwise modified and that other implementations are possible.

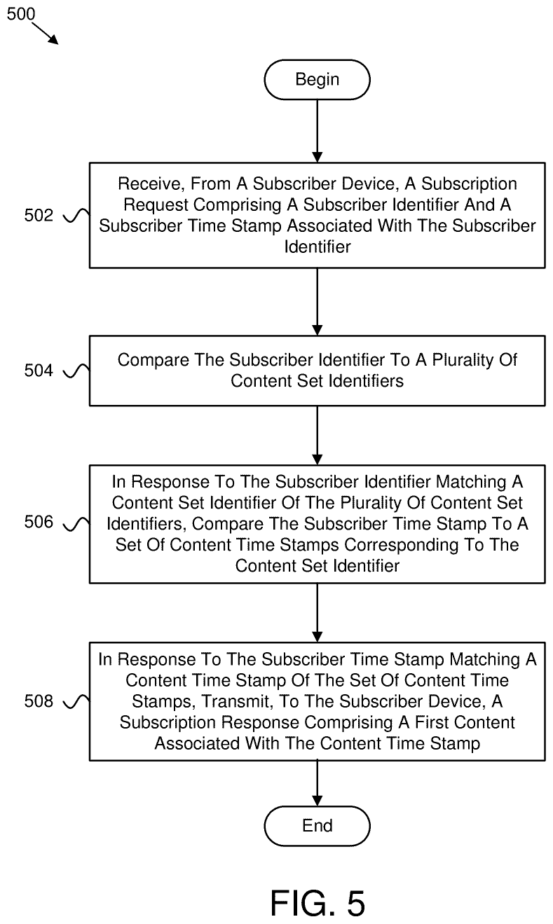

FIG. 5 illustrates a method 500 performed by a content server. At 502, the content server receives, from a subscriber device, a subscription request comprising a subscriber identifier and a subscriber time stamp associated with the subscriber identifier. At 504, the content server compares the subscriber identifier to a plurality of content set identifiers stored by the content server or an associated registry. Upon identifying a matching content set identifier, the content server compares, at 506, the subscriber time stamp to a set of content time stamps corresponding to the content set identifier. The content time stamps may represent different campaigns, broadcasts, placements, or temporal windows associated with the same identifier. At 508, when the subscriber time stamp matches a content time stamp, the content server transmits a subscription response comprising first content associated with the matched content time stamp.

This two-stage matching process enables reuse of identifiers across multiple content instances while ensuring that the subscriber receives the correct content corresponding to when the identifier was encountered. In some embodiments, the matching may include tolerances, ranges, or nearest-neighbor selection rather than exact time equality.

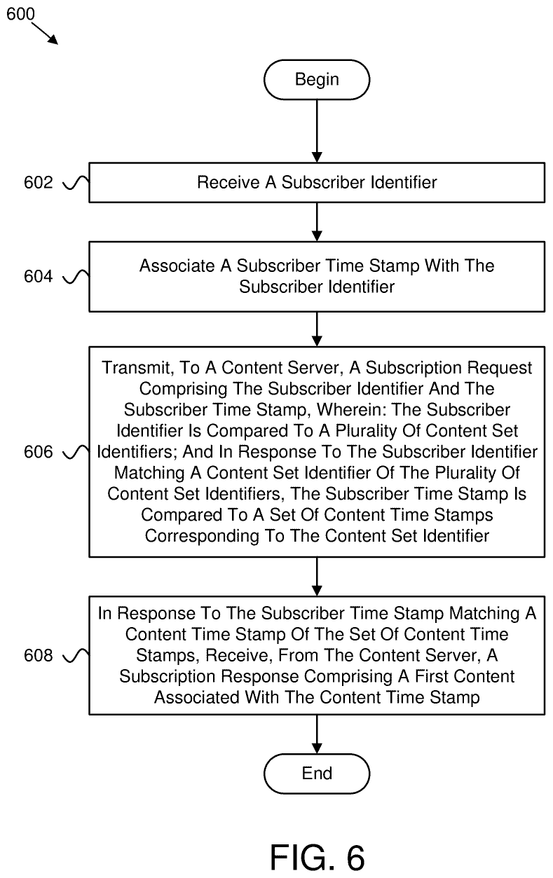

FIG. 6 illustrates a method 600 performed by a subscriber device (e.g., cell phone, computer, etc.). At 602, the subscriber device receives or captures a subscriber identifier. At 604, the subscriber device associates a subscriber time stamp with the subscriber identifier. At 606, the subscriber device transmits a subscription request to the content server, including the subscriber identifier and subscriber time stamp. At 608, the subscriber device receives a subscription response comprising content associated with the subscriber identifier and time stamp.

In various embodiments, the content server may associate additional or follow-up content with the first content. The first content may comprise one or more uniform resource locators (URLs), application deep links, multimedia files, or other digital resources. The subscription response transmitted to the subscriber device may include the subscriber identifier, enabling the subscriber device to associate the delivered content with the identifier originally submitted in the subscription request, thereby maintaining continuity between identifier capture, content resolution, and user history. Follow-up content may be transmitted automatically after a predetermined time period, conditionally in response to the subscriber accessing the first content, or selectively based on user preferences. The subscriber device may provide notifications indicating the availability of follow-up content, and the user may control whether such follow-up content is received.

In some embodiments, the subscription request may further include subscriber location information, such as GPS coordinates. The content server may use the subscriber location information in combination with the subscriber identifier and subscriber time stamp to further refine content selection or analytics.

The disclosed system enables a reduction in repeated exposures required for user engagement, supports delayed and asynchronous interaction with content, and provides content providers with improved attribution and analytics. The described methods may be performed by one or more processors executing instructions stored in non-transitory computer-readable media, and the operations may be rearranged, combined, or omitted without departing from the scope of the disclosure.

The disclosed content management system enables consumers to subscribe to content using identifiers—such as words, phrases, or symbols—embedded within or associated with media content. These identifiers, referred to herein in some embodiments as “snagtags,” act as controlled registration and linking mechanisms between content providers and consumers.

A consumer may encounter snagtag-enabled content in visual, audio, or mixed-media environments. Using a subscriber device, such as a smartphone or tablet, the consumer may register interest in the content by submitting a subscription request that includes the identifier and a time stamp indicating when the identifier was encountered. The time stamp provides temporal context that enables the system to disambiguate between multiple content instances using the same identifier.

In some embodiments, each identifier is associated with a content set that includes multiple content items corresponding to different time intervals, locations, campaigns, or media placements. For example, a single identifier may be reused across multiple advertisements or broadcasts, each mapped to a different content time stamp window.

When the content server receives a subscription request, the server compares the identifier to registered content set identifiers and then evaluates the subscriber time stamp against content time stamps to select the most relevant content. This temporal matching enables accurate delivery even when identifiers are reused across campaigns.

The content server may associate secondary or follow-up content with primary content items. Follow-up content may include promotional offers, reminders, updates, or related material. Delivery of follow-up content may be time-based, event-based, or action-based. For example, follow-up content may be transmitted only after a subscriber opens the initial content, views a resource, or performs a conversion action.

Subscribers retain full control over subscribed content. In various embodiments, subscribers may disable follow-ups, delete subscriptions, archive content for later viewing, or mark content as preferred. A subscriber device may maintain a persistent history or inbox of subscribed content, enabling delayed engagement without loss of context.

The disclosed system enables collection of detailed metrics, including but not limited to number of subscriptions, views, deletes, shares, follow-up interactions, click-through rates, conversion rates, geographic distribution, time-of-day effectiveness, and campaign return on investment. These metrics may be aggregated and provided to content providers through analytics interfaces.

The content management system may include one or more content servers, registries, analytics engines, and subscriber devices interconnected via one or more networks. Content servers may include processors, memories, and controllers configured to execute instructions stored in non-transitory computer-readable media to perform the disclosed methods.

The present disclosure is not limited to the specific embodiments described herein. Variations and modifications will be apparent to persons of ordinary skill in the art and are intended to fall within the scope of the appended claims.

One example of a device that may perform the methods described herein may include a processor, a memory, and a controller. The processor, the memory, or the controller, or various combinations thereof or various components thereof may be examples of means for performing various aspects of the present disclosure as described herein. These components may be coupled (e.g., operatively, communicatively, functionally, electronically, electrically) via one or more interfaces.

The processor, the memory, or the controller, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor may include an intelligent hardware device (e.g., a general-purpose processor, a DSP, a CPU, an ASIC, an FPGA, or any combination thereof). In some implementations, the processor may be configured to operate the memory. In some other implementations, the memory may be integrated into the processor. The processor may be configured to execute computer-readable instructions stored in the memory to cause the device to perform various functions of the present disclosure.

The memory may include volatile or non-volatile memory. The memory may store computer-readable, computer-executable code including instructions when executed by the processor cause the device to perform various functions described herein. The code may be stored in a non-transitory computer-readable medium such the memory or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor and the memory coupled with the processor may be configured to cause the device to perform one or more of the functions described herein (e.g., executing, by the processor, instructions stored in the memory. For example, the processor may support wireless communication at the device in accordance with examples as disclosed herein.

The controller may manage input and output signals for the device. The controller may also manage peripherals not integrated into the device. In some implementations, the controller may utilize an operating system such as iOS®, ANDROID®, WINDOWS®, or other operating systems. In some implementations, the controller may be implemented as part of the processor.

The processor may be configured to perform various operations in accordance with examples as described herein. The processor may include a controller configured to perform various operations in accordance with examples as described herein. The processor may optionally include at least one memory, which may be, for example, an L1/L2/L3 cache. Additionally, or alternatively, the processor may optionally include one or more arithmetic-logic units (ALUs). One or more of these components may be in electronic communication or otherwise coupled (e.g., operatively, communicatively, functionally, electronically, electrically) via one or more interfaces (e.g., buses).

The processor may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller may be configured to manage and coordinate various operations (e.g., signaling, receiving, obtaining, retrieving, transmitting, outputting, forwarding, storing, determining, identifying, accessing, writing, reading) of the processor to cause the processor to support various operations in accordance with examples as described herein. For example, the controller may operate as a control unit of the processor, generating control signals that manage the operation of various components of the processor. These control signals include enabling or disabling functional units, selecting data paths, initiating memory access, and coordinating timing of operations.

The controller may be configured to fetch (e.g., obtain, retrieve, receive) instructions from the memory and determine subsequent instruction(s) to be executed to cause the processor to support various operations in accordance with examples as described herein. The controller may be configured to track memory address of instructions associated with the memory. The controller may be configured to decode instructions to determine the operation to be performed and the operands involved. For example, the controller may be configured to interpret the instruction and determine control signals to be output to other components of the processor to cause the processor to support various operations in accordance with examples as described herein. Additionally, or alternatively, the controller may be configured to manage flow of data within the processor. The controller may be configured to control transfer of data between registers, arithmetic logic units (ALUs), and other functional units of the processor.

The memory may include one or more caches (e.g., memory local to or included in the processor or other memory, such RAM, ROM, DRAM, SDRAM, SRAM, MRAM, flash memory, etc. In some implementations, the memory may reside within or on a processor chipset (e.g., local to the processor). In some other implementations, the memory may reside external to the processor chipset (e.g., remote to the processor).

The memory may store computer-readable, computer-executable code including instructions that, when executed by the processor, cause the processor to perform various functions described herein. The code may be stored in a non-transitory computer-readable medium such as system memory or another type of memory. The controller and/or the processor may be configured to execute computer-readable instructions stored in the memory to cause the processor to perform various functions. For example, the processor and/or the controller may be coupled with or to the memory, the processor, the controller, and the memory may be configured to perform various functions described herein. In some examples, the processor may include multiple processors and the memory may include multiple memories. One or more of the multiple processors may be coupled with one or more of the multiple memories, which may, individually or collectively, be configured to perform various functions herein.

The one or more ALUs may be configured to support various operations in accordance with examples as described herein. In some implementations, the one or more ALUs may reside within or on a processor chipset (e.g., the processor). In some other implementations, the one or more ALUs may reside external to the processor chipset (e.g., the processor). One or more ALUs may perform one or more computations such as addition, subtraction, multiplication, and division on data. For example, one or more ALUs may receive input operands and an operation code, which determines an operation to be executed. One or more ALUs be configured with a variety of logical and arithmetic circuits, including adders, subtractors, shifters, and logic gates, to process and manipulate the data according to the operation. Additionally, or alternatively, the one or more ALUs may support logical operations such as AND, OR, exclusive-OR (XOR), not-OR (NOR), and not-AND (NAND), enabling the one or more ALUs to handle conditional operations, comparisons, and bitwise operations.

It should be noted that the method described herein describes A possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method performed by a content server, the method comprising:
receiving, from a subscriber device, a subscription request comprising a subscriber identifier and a subscriber time stamp associated with the subscriber identifier;
comparing the subscriber identifier to a plurality of content set identifiers;
in response to the subscriber identifier matching a content set identifier of the plurality of content set identifiers, comparing the subscriber time stamp to a set of content time stamps corresponding to the content set identifier; and
in response to the subscriber time stamp matching a content time stamp of the set of content time stamps, transmitting, to the subscriber device, a subscription response comprising a first content associated with the content time stamp.

2. The method of claim 1, wherein the subscription response comprises the subscriber identifier.

3. The method of claim 1, further comprising associating a second content with the first content.

4. The method of claim 3, further comprising transmitting the second content to the subscriber device after a predetermined time period.

5. The method of claim 1, further comprising receiving a notification in response to the first content being accessed at the subscriber device.

6. The method of claim 5, further comprising transmitting a second content associated with the first content to the subscriber device in response to receiving the notification.

7. The method of claim 1, further comprising storing information corresponding to receiving the subscription request.

8. The method of claim 7, further comprising associating a user identifier corresponding to the subscriber device with the stored information.

9. The method of claim 1, further comprising receiving a plurality of subscription requests comprising a plurality of subscriber identifiers associated with a corresponding subscriber time stamp of a plurality of subscriber time stamps.

10. The method of claim 9, further comprising storing information corresponding to the plurality of subscription requests.

11. The method of claim 10, further comprising associating a user identifier corresponding to the subscriber device with the stored information.

12. The method of claim 1, wherein the subscription request comprises a subscriber location.

13. The method of claim 12, wherein the subscriber location comprises a geospatial positioning system (GPS) location.

14. The method of claim 1, wherein the subscriber identifier comprises a word or phrase.

15. The method of claim 1, wherein the first content comprises a uniform resource locator (URL).

16. A content server, comprising:
at least one memory; and
at least one processor coupled with the at least one memory and configured to cause the content server to:
receive, from a subscriber device, a subscription request comprising a subscriber identifier and a subscriber time stamp associated with the subscriber identifier;
compare the subscriber identifier to a plurality of content set identifiers;
in response to the subscriber identifier matching a content set identifier of the plurality of content set identifiers, compare the subscriber time stamp to a set of content time stamps corresponding to the content set identifier; and
in response to the subscriber time stamp matching a content time stamp of the set of content time stamps, transmit, to the subscriber device, a subscription response comprising a first content associated with the content time stamp.

17. A processor, comprising:
at least one controller coupled with at least one memory and configured to cause the processor to:
receive, from a subscriber device, a subscription request comprising a subscriber identifier and a subscriber time stamp associated with the subscriber identifier;
compare the subscriber identifier to a plurality of content set identifiers;
in response to the subscriber identifier matching a content set identifier of the plurality of content set identifiers, compare the subscriber time stamp to a set of content time stamps corresponding to the content set identifier; and
in response to the subscriber time stamp matching a content time stamp of the set of content time stamps, transmit, to the subscriber device, a subscription response comprising a first content associated with the content time stamp.

18. A method performed by a subscriber device, the method comprising:
receiving a subscriber identifier;
associating a subscriber time stamp with the subscriber identifier;
transmitting, to a content server, a subscription request comprising the subscriber identifier and the subscriber time stamp, wherein:
the subscriber identifier is compared to a plurality of content set identifiers; and
in response to the subscriber identifier matching a content set identifier of the plurality of content set identifiers, the subscriber time stamp is compared to a set of content time stamps corresponding to the content set identifier; and
in response to the subscriber time stamp matching a content time stamp of the set of content time stamps, receiving, from the content server, a subscription response comprising a first content associated with the content time stamp.

19. The method of claim 18, further comprising associating a subscriber location with the subscriber identifier.

20. A subscriber device, comprising:
at least one memory; and
at least one processor coupled with the at least one memory and configured to cause the subscriber device to:
receive a subscriber identifier;
associate a subscriber time stamp with the subscriber identifier;
transmit, to a content server, a subscription request comprising the subscriber identifier and the subscriber time stamp, wherein:
the subscriber identifier is compared to a plurality of content set identifiers; and
in response to the subscriber identifier matching a content set identifier of the plurality of content set identifiers, the subscriber time stamp is compared to a set of content time stamps corresponding to the content set identifier; and
in response to the subscriber time stamp matching a content time stamp of the set of content time stamps, receive, from the content server, a subscription response comprising a first content associated with the content time stamp.

21. A processor, comprising:
at least one controller coupled with at least one memory and configured to cause the processor to:
receive a subscriber identifier;
associate a subscriber time stamp with the subscriber identifier;
transmit, to a content server, a subscription request comprising the subscriber identifier and the subscriber time stamp, wherein:
the subscriber identifier is compared to a plurality of content set identifiers; and
in response to the subscriber identifier matching a content set identifier of the plurality of content set identifiers, the subscriber time stamp is compared to a set of content time stamps corresponding to the content set identifier; and
in response to the subscriber time stamp matching a content time stamp of the set of content time stamps, receive, from the content server, a subscription response comprising a first content associated with the content time stamp.
